(19) United States
(12) Patent Application Publication
(10) Pub. No.: US 2025/0206263 A1
(43) Pub. Date: Jun. 26, 2025

(54) INFORMATION PROCESSING DEVICE, NETWORK SYSTEM, AND CALIBRATION METHOD

(71) Applicant: TOYOTA JIDOSHA KABUSHIKI KAISHA, Toyota-shi (JP)

(72) Inventors: Hiroki HOMMA, Toyota-shi (JP); Yosuke HASEGAWA, Niwa-gun (JP); Junji MURASE, Nagoya-shi (JP); Yuki MORI, Niwa-gun (JP)

(73) Assignee: TOYOTA JIDOSHA KABUSHIKI KAISHA, Toyota-shi (JP)

(21) Appl. No.: 18/966,993

(22) Filed: Dec. 3, 2024

(30) Foreign Application Priority Data
Dec. 21, 2023 (JP) 2023-215851

(51) Int. Cl. B60R 25/24

(52) U.S. Cl. CPC B60R 25/24; B60R 2325/101

(57) ABSTRACT

An information processing device is configured to communicate with both a vehicle and a mobile information terminal in which a digital key for the vehicle is registered. The information processing device includes a processing circuit and a storage device. The storage device stores a database, in which a correction value for calibration of the ranging, performed by the vehicle to determine that the mobile information terminal is within an operating area of the digital key, is recorded in advance for each model of the mobile information terminal. The processing circuit is configured to execute acquiring of information identifying the model from the mobile information terminal, extracting of the correction value corresponding to the model of the mobile information terminal from the database, based on the information that is acquired, and transmitting of the correction value that is extracted to the vehicle.

### CROSS-REFERENCE TO RELATED APPLICATION

This application claims priority to Japanese Patent Application No. 2023-215851 filed on Dec. 21, 2023, incorporated herein by reference in its entirety.

### BACKGROUND

### 1. Technical Field

The present disclosure relates to an information processing device, a network system, and a calibration method.

### 2. Description of Related Art

Japanese Patent Application Publication No. 2023-98289 (JP 2023-98289 A) discloses an information processing device to be used for a digital key. The information processing device disclosed in JP 2023-98289 A is installed a vehicle. The information processing device disclosed in JP 2023-98289 A performs measurement of distance between the vehicle and an information processing terminal, and measurement of signal strength. Then, based on the measurement results, the information processing device calibrates a Bluetooth Low Energy (BLE) connection area in which locking and unlocking are performed using a digital key.

### SUMMARY

The information processing device described above performs measurement of distance and measurement of signal strength in a vehicle, and calculates a correction value. Accordingly, processing for measurement and calculation of correction values need to be executed in each vehicle.

Means for solving the above problems, and operations and effects thereof, will be described below. In order to solve the above problem, an information processing device according to a first aspect of the present disclosure is configured to communicate with both a vehicle and a mobile information terminal in which a digital key for the vehicle is registered. This information processing device includes a processing circuit and a storage device. A database, in which a correction value for calibration of ranging, performed by the vehicle to determine that the mobile information terminal is within an operating area of the digital key, is recorded in advance for each model of the mobile information terminal, is stored in the storage device. The processing circuit is configured to execute acquiring of information for identifying the model from the mobile information terminal. The processing circuit is configured to execute extracting of the correction value corresponding to the model of the mobile information terminal, from the database, based on the information that is acquired. The processing circuit is configured to execute transmitting of the correction value that is extracted, to the vehicle.

In the information processing device according to the first aspect of the present disclosure, the vehicle may be configured to perform the ranging through communication with the mobile information terminal by Bluetooth Low Energy (BLE), and the processing circuit may be configured to execute transmitting of a correction value regarding the communication by the BLE, as the correction value.

In the information processing device according to the first aspect of the present disclosure, the vehicle may be configured to perform the ranging through communication with the mobile information terminal by ultra wide band (UWB), and the processing circuit may be configured to execute transmitting of a correction value regarding the communication by the UWB, as the correction value.

A network system according to a second aspect of the present disclosure for solving the above problem includes a vehicle, a mobile information terminal in which a digital key of the vehicle is registered, and an information processing device. The vehicle, the mobile information terminal, and the information processing device are connected to communicate with each other. In this network system, the information processing device includes a processing circuit and a storage device. A database, in which a correction value for calibration of ranging, performed by the vehicle to determine that the mobile information terminal is within an operating area of the digital key, is recorded in advance for each model of the mobile information terminal, is stored in the storage device. In this network system, the processing circuit of the information processing device is configured to execute acquiring of information for identifying the model from the mobile information terminal. In this network system, the processing circuit of the information processing device is configured to execute extracting of the correction value corresponding to the model of the mobile information terminal, from the database, based on the information that is acquired. In this network system, the processing circuit of the information processing device is configured to execute transmitting of the correction value that is extracted, to the vehicle. In this network system, the vehicle is configured to perform calibration of the ranging based on the correction value that is received.

In the network system according to the second aspect of the present disclosure, the vehicle may be configured to perform the ranging through communication with the mobile information terminal by Bluetooth Low Energy (BLE), and the processing circuit may be configured to execute transmitting of a correction value regarding the communication by the BLE, as the correction value.

In the network system according to the second aspect of the present disclosure, the vehicle may be configured to perform the ranging through communication with the mobile information terminal by ultra wide band (UWB), and the processing circuit may be configured to execute transmitting of a correction value regarding the communication by the UWB, as the correction value.

In the network system according to the second aspect of the present disclosure, the processing circuit may be configured to, when pairing between an owner terminal that is the mobile information terminal owned by an owner of the vehicle and the vehicle is completed and an owner key that is the digital key for the owner of the vehicle is generated and enabled in the owner terminal, execute transmitting of the correction value regarding the owner terminal to the vehicle.

A calibration method according to a third aspect of the present disclosure for solving the above problem is applied to a network system in which a vehicle, a mobile information terminal in which a digital key for the vehicle is registered, and an information processing device are connected to communicate with each other. In the network system, the information processing device includes a processing circuit and a storage device. A database, in which a correction value for calibration of ranging, performed by the vehicle to determine that the mobile information terminal is within an operating area of the digital key, is recorded in advance for each model of the mobile information terminal, is stored in the storage device. The calibration method includes executing acquiring of information identifying the model from the mobile information terminal, using the processing circuit. The calibration method includes executing extracting of the correction value corresponding to the model of the mobile information terminal based on the information that is acquired, from the database, using the processing circuit. The calibration method includes executing transmitting of the correction value that is extracted, to the vehicle, using the processing circuit. The calibration method includes calibrating the ranging based on the correction value that is received, using the vehicle.

The information processing device, the network system, and the calibration method can realize calibration without increasing a processing load in the vehicle or overwhelming capacity of the storage device on the vehicle side due to the database.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram illustrating a configuration of a network system according to an embodiment;

FIG. 2 is a schematic diagram illustrating operating areas of a vehicle in the network system according to the embodiment;

FIG. 3 is a table showing contents of a database stored in a storage device of an information processing device in the network system of the embodiment;

FIG. 4 is a sequence diagram showing a mode of communication executed among an owner terminal, the information processing device, and the vehicle, in the network system of the embodiment; and

FIG. 5 is a sequence diagram showing a mode of communication executed among a friend terminal, the owner terminal, the information processing device, and the vehicle, in the network system of the embodiment.

### DETAILED DESCRIPTION OF EMBODIMENTS

### Configuration of Network System 100

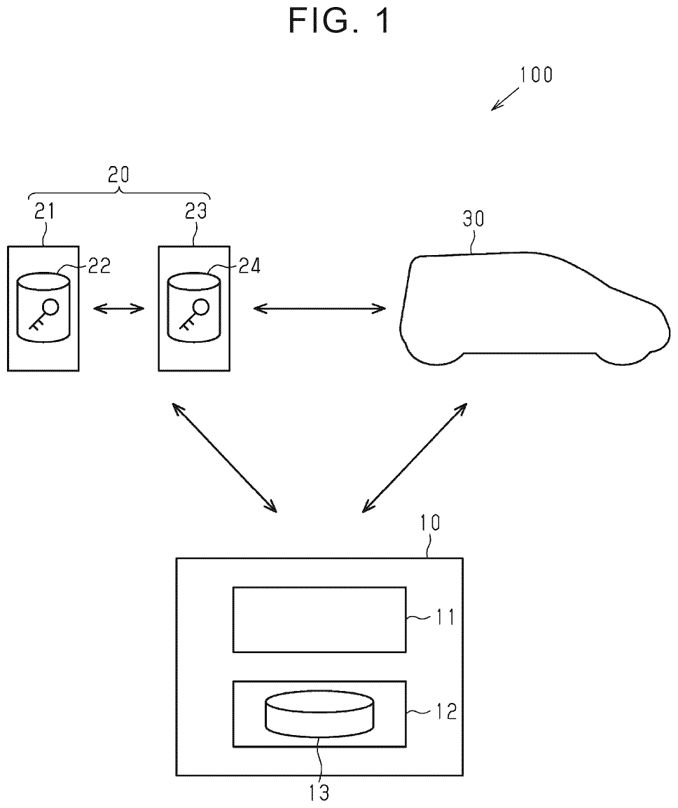

An embodiment of a network system will be described below with reference to FIGS. 1 to 5. As illustrated in FIG. 1, a network system 100 is made up of an information processing device 10, a mobile information terminal 20, and a vehicle 30. The information processing device 10, the mobile information terminal 20, and the vehicle 30 are communicably connected to each other.

As illustrated in FIG. 1, the information processing device 10 includes a processing circuit 11 and a storage device 12. The storage device 12 stores a program and a database 13. The database 13 will be described later. The processing circuit 11 executes programs stored in the storage device 12 to execute various types of processing. The processing circuit 11 includes a processor.

A digital key for the vehicle 30 is registered in the mobile information terminal 20. Accordingly, an owner of the mobile information terminal 20 can lock or unlock the vehicle 30 by performing operations from the mobile information terminal 20.

Mobile information terminals 20 include owner terminals 21 and friend terminals 23. The owner terminal 21 and the friend terminal 23 are communicable with each other. The owner terminal 21 is a mobile information terminal 20 owned by the owner of the vehicle 30. An owner key 22, which is a digital key for the owner, is registered in the owner terminal 21.

The friend terminal 23 is a mobile information terminal 20 owned by another particular user who has been permitted by the owner to use the vehicle 30. A friend key 24, which is a digital key for the particular user, is registered in the friend terminal 23. The friend key 24 is issued when the owner applies for a digital key, for the vehicle 30 that he or she owns, to be issued for the particular user.

The owner terminal 21 in which the owner key 22 is registered serves to carry out the same functions as a normal smart key. That is to say, the owner can lock and unlock the vehicle 30 by operating the owner terminal 21. Also, when the owner terminal 21 is present in the vehicle 30, a driver of the vehicle 30 can operate an engine.

The owner can set restrictions on functions that can be used on the friend terminal 23 to which the friend key 24 is registered. For example, when permitted by the owner to only lock and unlock the vehicle 30, the owner of the friend terminal 23 can only lock and unlock the vehicle 30 by operating the friend terminal 23. Also, for example, when receiving permission from the owner to drive the vehicle 30, the owner of the friend terminal 23 can operate the engine and drive the vehicle 30 in a state in which the friend terminal 23 is present inside the vehicle 30.

### Overview of Operating Area of Vehicle 30

An operating area for the digital key is defined with respect to the vehicle 30. The operating area is a range over which the vehicle 30 responds to operations using the digital key. The vehicle 30 responds to operations using the digital key within the range of the operating area, and performs locking and unlocking, and so forth. Also, the vehicle 30 will not allow the engine to be run when the mobile information terminal 20 to which the digital key is registered is not within the range of the operating area.

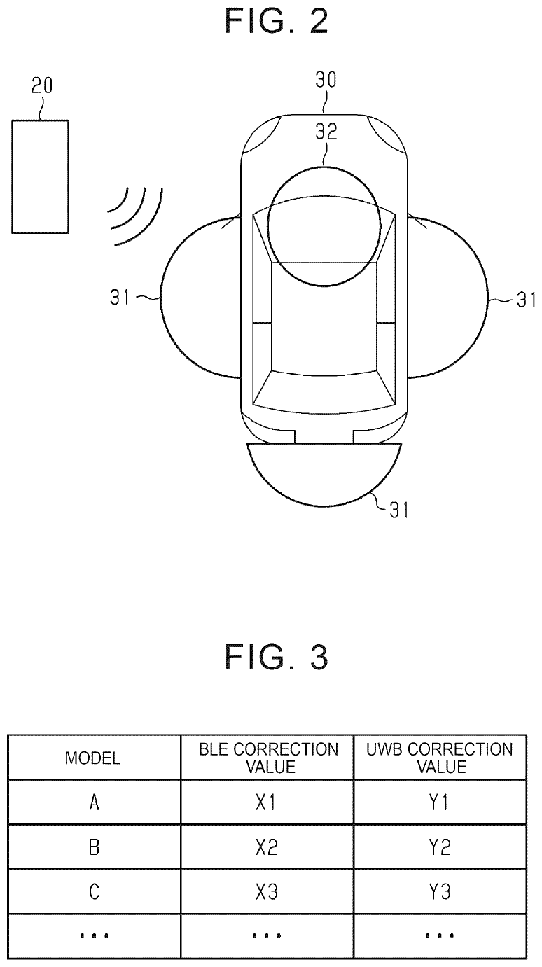

FIG. 2 illustrates the ranges of the operating areas of the vehicle 30. As illustrated in FIG. 2, the operating areas include first operating areas 31 and a second operating area 32. As illustrated in FIG. 2, the first operating areas 31 are set on the sides and rear of the vehicle 30. The owner of the mobile information terminal 20 to which the digital key is registered can execute locking and unlocking of the vehicle 30 by operating the mobile information terminal 20 within the first operating areas 31.

As illustrated in FIG. 2, the second operating area 32 is set in a vicinity of the driver's seat and the passenger seat of the vehicle 30. The owner of the mobile information terminal 20 to which the digital key is registered cannot operate the engine of the vehicle 30 when the mobile information terminal 20 is not within the second operating area 32.

The vehicle 30 communicates with the mobile information terminal 20 by Bluetooth Low Energy (BLE) and ultra wide band (UWB). The vehicle 30 can perform low power consumption communication by communicating with the mobile information terminal 20 by communication by BLE. On the other hand, the vehicle 30 can perform ultra wide band communication with the mobile information terminal 20 by performing communication by UWB. The vehicle 30 performs ranging through communication by BLE and UWB to determine whether the mobile information terminal 20 is within the operating area of the digital key. The vehicle 30 determines that the mobile information terminal 20 is within the operating area of the digital key when signal strengths of both the communication by BLE and the communication by UWB are no less than a predetermined value. Alternatively, the vehicle 30 determines that the mobile information terminal 20 is within the operating area of the digital key when the signal strength of one of the communications is no less than a predetermined value.

### Overview of Database 13 Stored in Information Processing Device 10

The signal strength when the mobile information terminal 20 communicates with another device by BLE and UWB varies depending on the model of the mobile information terminal 20. Accordingly, in order to standardize the size of the operating area of the digital key, the vehicle 30 performs calibration regarding ranging through communication by BLE and UWB for each model of the mobile information terminal 20.

The information processing device 10 stores, in the storage device 12, the database 13 in which correction values for calibration of ranging are recorded. FIG. 3 shows the database 13 stored in the storage device 12.

As shown in FIG. 3, the database 13 stores correction values for calibration of ranging for each model of the mobile information terminal 20. In FIG. 3, the models of the mobile information terminals 20 are represented by symbols such as “A”, “B”, and “C”.

Also recorded in the database 13 are a correction value regarding communication by BLE, and a correction value regarding communication by UWB, for each model of the mobile information terminal 20. In FIG. 3, correction values regarding communication by BLE are represented by symbols such as “X1”, “X2”, and “X3”. Also, in FIG. 3, correction values regarding communication by UWB are represented by symbols such as “Y1”, “Y2”, and “Y3”.

In order to create such a database 13, a creator of the database 13 measures the signal strength of communication between the mobile information terminal 20 and other devices by BLE and UWB, for each model of the mobile information terminal 20. The creator of the database 13 then sets a correction value for each model such that the size of the operating area of the digital key in the vehicle 30 can be standardized. The correction values thus set are recorded in the database 13.

In the network system 100, the correction value is a correction value regarding the signal strength of the communication between the vehicle 30 and the mobile information terminal 20. For example, when the signal strength of the communication by BLE when the mobile information terminal 20 of model A reaches an outer edge of the operating area is 3 dB higher than a preset value, the correction value X1 regarding the communication by BLE is-3 dB.

In the network system 100, the correction value may be a correction value regarding the operating area of the digital key in the vehicle 30. For example, when the signal strength of communication by UWB between the mobile information terminal 20 of model A and the vehicle 30 reaches a preset value, and the mobile information terminal 20 is located 30 cm inside the operating area, the correction value Y1 regarding communication by UWB will be +30 cm.

In this way, the information processing device 10 stores, in the storage device 12, the database 13 in which correction values for calibration of ranging are recorded in advance for each model of the mobile information terminal 20.

Communication Mode of Network System 100 when Registering Owner Key 22

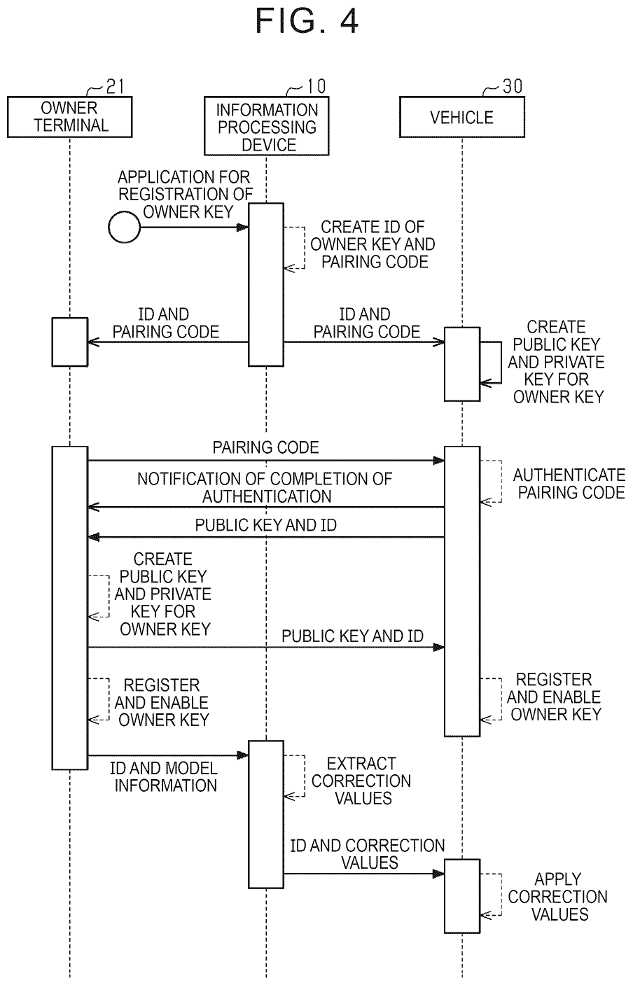

FIG. 4 shows a flow of communication when the owner terminal 21 and the vehicle 30 register the owner key 22 in the network system 100. The owner key 22 is registered in both the owner terminal 21 and the vehicle 30, and thereafter is enabled, whereby the owner of the owner terminal 21 is able to operate the vehicle 30 using the owner terminal 21.

As shown in the upper part of FIG. 4, the information processing device 10 receives an application for registration of the owner key 22. After the owner of the vehicle 30 signs a contract for the owner key 22 at a dealer that sold the vehicle 30, for example, the application for registration of the owner key 22 is transmitted to the information processing device 10 from the dealer where the contract was signed. Also, the application for registration of the owner key 22 may be transmitted, for example, from the owner terminal 21 to the information processing device 10.

As shown in the upper part of FIG. 4, the processing circuit 11 of the information processing device 10 that receives the application for registration for the owner key 22 creates an ID of the owner key 22 and a pairing code. The ID of the owner key 22 is an ID created for identifying the owner key 22. The pairing code is a code necessary for pairing between the mobile information terminal 20 and the vehicle 30.

As shown in the upper part of FIG. 4, the processing circuit 11 transmits the ID of the owner key 22 and the pairing code to the owner terminal 21 and the vehicle 30. The vehicle 30 that has received the ID of the owner key 22 and the pairing code then creates a public key and a private key for the owner key 22.

As shown in the middle part of FIG. 4, the owner terminal 21 transmits the pairing code to the vehicle 30 under operations by the owner. As shown in the middle part of FIG. 4, the vehicle 30 that has received the pairing code from the owner terminal 21 performs authentication of the pairing code. In the authentication of the pairing code, the vehicle 30 matches the pairing code received from the information processing device 10 in the upper part of FIG. 4 with the pairing code received from the owner terminal 21 in the middle part of FIG. 4. The vehicle 30 then confirms that the pairing code received from the information processing device 10 and the pairing code received from the owner terminal 21 agree.

As shown in the middle part of FIG. 4, upon confirming that the pairing codes agree, the vehicle 30 transmits a notification of completion of authentication of the pairing code to the owner terminal 21. When the notification of completion of authentication is transmitted from the vehicle 30, pairing between the owner terminal 21 and the vehicle 30 is completed.

As shown in the middle part of FIG. 4, after pairing is completed, the vehicle 30 transmits the public key of the owner key 22 and the ID of the owner key 22 to the owner terminal 21. As shown in the middle part of FIG. 4, after receiving the public key and so forth from the vehicle 30, the owner terminal 21 creates a public key and a private key of the owner key 22. In this way, the owner key 22 is generated in the owner terminal 21.

As shown in the middle part of FIG. 4, the owner terminal 21 transmits the created public key together with the ID of the owner key 22 to the vehicle 30. As shown in the middle part of FIG. 4, after transmitting the public key of the owner key 22, the owner terminal 21 registers the owner key 22. When registering the owner key 22, the owner terminal 21 creates a common key for the owner key 22 from the private key of the owner key 22 that it has created itself and the public key that it has received from the vehicle 30. Thereafter, the common key of the owner key 22 that is created is associated with the ID of the owner key 22 received from the information processing device 10, and stored.

As shown in the middle part of FIG. 4, the vehicle 30 registers the owner key 22 in the same way that the owner terminal 21 does. The vehicle 30 creates a common key for the owner key 22 from the private key of the owner key 22 that it has created itself and the public key received from the owner terminal 21. The common key of the owner key 22 that is created is then associated with the ID of the owner key 22 received from the information processing device 10 and stored, thereby registering the owner key 22.

The owner key 22 registered in both the owner terminal 21 and the vehicle 30 is enabled between the owner terminal 21 and the vehicle 30. The owner key 22 thus enabled can be used in the owner terminal 21 as a digital key for the vehicle 30.

As shown in the lower part of FIG. 4, the owner terminal 21, for which registration of the owner key 22 has been completed, transmits the ID of the owner key 22 and model information of the owner terminal 21 to the information processing device 10. In this way, the processing circuit 11 of the information processing device 10 executes acquisition of information for identifying the model of the owner terminal 21 from the owner terminal 21 which is the mobile information terminal 20.

The processing circuit 11, having acquired the information for identifying the model of the owner terminal 21, searches the database 13 for correction values corresponding to the model of the owner terminal 21. The processing circuit 11 then extracts correction values corresponding to the model of the owner terminal 21 from the database 13, as shown in the lower part of FIG. 4.

As shown in the lower part of FIG. 4, the processing circuit 11 transmits the correction values extracted from the database 13 and the ID of the owner key 22 to the vehicle 30. In this way, the processing circuit 11 of the information processing device 10 transmits to the vehicle 30 a correction value regarding communication by BLE and a correction value regarding communication by UWB, which correspond to the model of the owner terminal 21.

As shown in the lower part of FIG. 4, the vehicle 30 that has received the correction values applies the received correction values to perform calibration of ranging. In this way, after pairing between the owner terminal 21 and the vehicle 30 is completed, the processing circuit 11 of the information processing device 10 transmits correction values regarding the owner terminal 21 to the vehicle 30 when the owner key 22 is generated and enabled in the owner terminal 21.

Communication Mode of Network System 100 when Registering Friend Key 24

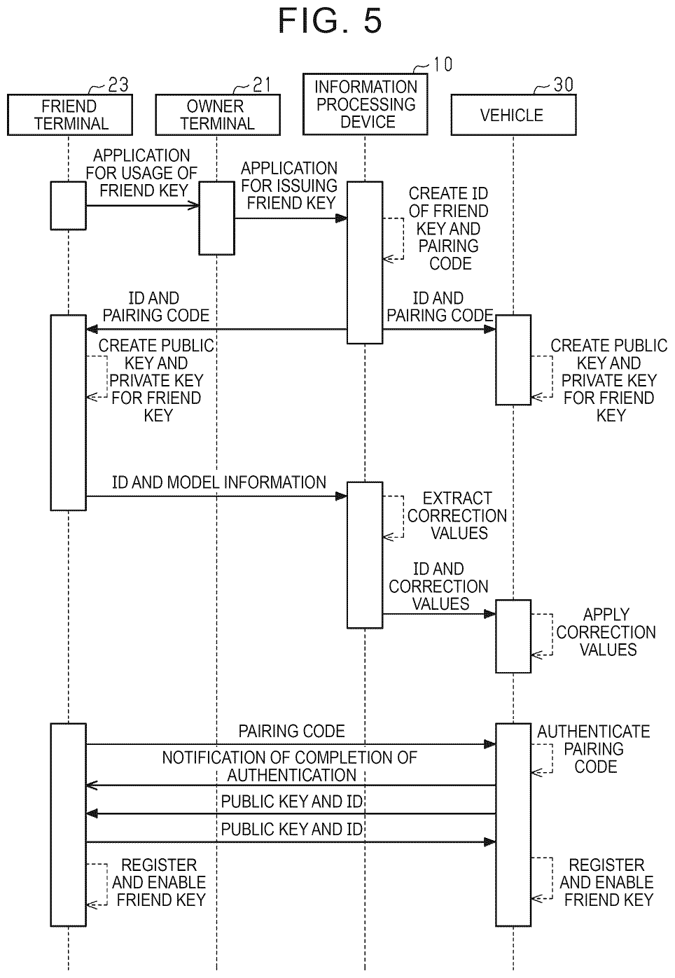

FIG. 5 shows a flow of communication when the friend terminal 23 and the vehicle 30 register the friend key 24 in the network system 100. The owner of the friend terminal 23 is able to operate the vehicle 30 using the friend terminal 23 by registering the friend key 24 in both the friend terminal 23 and the vehicle 30 and thereafter enabling the friend key 24.

As shown in the upper part of FIG. 5, the friend terminal 23 transmits to the owner terminal 21 an application for usage of the friend key 24. After the owner terminal 21 receives the application for usage of the friend key 24, and the owner consents to the application for usage of the friend key 24, the owner terminal 21 transmits to the information processing device 10 an application for issuing the friend key 24, as shown in the upper part of FIG. 5. In this way, the owner applies for a digital key for the vehicle 30 that he or she owns to be issued for use by another particular user.

As shown in the upper part of FIG. 5, after receiving usage permission information, the processing circuit 11 of the information processing device 10 creates an ID of the friend key 24, and a pairing code. The ID of the friend key 24 is an ID created to identify the friend key 24.

As shown in the upper part of FIG. 5, the processing circuit 11 transmits the ID of the friend key 24 and the pairing code to the vehicle 30. The vehicle 30 that has received the ID of the friend key 24 and the pairing code then creates a public key and a private key for the friend key 24.

As shown in the upper part of FIG. 5, the processing circuit 11 transmits the ID of the friend key 24 and the pairing code to the friend terminal 23. The friend terminal 23 that has received the ID of the friend key 24 and the pairing code then creates a public key and a private key for the friend key 24. In this way, the friend key 24 is issued to the friend terminal 23.

As shown in the middle part of FIG. 5, the friend terminal 23 that has created the public key and the private key of the friend key 24 transmits the ID of the friend key 24 and model information of the friend terminal 23 to the information processing device 10. In this way, the processing circuit 11 of the information processing device 10 obtains, from the friend terminal 23 which is the mobile information terminal 20, information for identifying the model of the friend terminal 23.

Upon having acquired the information for identifying the model of the friend terminal 23, the processing circuit 11 searches the database 13 for correction values corresponding to the model of the friend terminal 23. The processing circuit 11 then extracts correction values corresponding to the model of the friend terminal 23 from the database 13, as shown in the middle part of FIG. 5.

As shown in the middle part of FIG. 5, the processing circuit 11 transmits the correction values extracted from the database 13 and the ID of the friend key 24 to the vehicle 30. At this time, the processing circuit 11 of the information processing device 10 transmits to the vehicle 30 a correction value regarding communication by BLE, and a correction value regarding communication by UWB, which correspond to the model of the friend terminal 23. In this way, when the friend key 24 is issued to the friend terminal 23, the processing circuit 11 of the information processing device 10 transmits the correction values regarding the friend terminal 23 to the vehicle 30.

As shown in the middle part of FIG. 5, the vehicle 30 that has received the correction values applies the correction values that are received to perform calibration of ranging. As shown in the lower part of FIG. 5, the friend terminal 23 transmits a pairing code to the vehicle 30 under an operation by the owner of the friend terminal 23.

As shown in the lower part of FIG. 5, the vehicle 30 that has received the pairing code from the friend terminal 23 performs authentication of the pairing code. In the authentication of the pairing code, the vehicle 30 matches the pairing code received from the information processing device 10 in the upper part of FIG. 5 with the pairing code received from the friend terminal 23 in the lower part of FIG. 5. The vehicle 30 then confirms that the pairing code received from the information processing device 10 and the pairing code received from the friend terminal 23 agree.

As shown in the lower part of FIG. 5, upon confirming that the pairing codes agree, the vehicle 30 transmits a notification of completion of authentication of the pairing code to the friend terminal 23. When the notification of completion of authentication is transmitted from the vehicle 30, pairing between the friend terminal 23 and the vehicle 30 is completed.

As shown in the lower part of FIG. 5, after pairing is completed, the vehicle 30 transmits the public key of the friend key 24 and the ID of the friend key 24 to the friend terminal 23. On the other hand, as shown in the lower part of FIG. 5, after pairing is completed, the friend terminal 23 transmits the public key of the friend key 24 and the ID of the friend key 24 to the vehicle 30.

As shown in the lower part of FIG. 5, after transmitting the public key of the friend key 24, the friend terminal 23 registers the friend key 24. When registering the friend key 24, the friend terminal 23 creates a common key for the friend key 24 from the private key of the friend key 24 created by itself, and the public key received from the vehicle 30. Thereafter, the common key of the friend key 24 that is created is associated with the ID of the friend key 24 received from the information processing device 10, and stored.

As shown in the lower part of FIG. 5, the vehicle 30 registers the friend key 24 in the same way that the friend terminal 23 does. The vehicle 30 creates a common key for the friend key 24 from the private key of the friend key 24 created by itself and the public key received from the friend terminal 23. The common key of the friend key 24 that is created is then associated with the ID of the friend key 24 received from the information processing device 10 and stored, thereby registering the friend key 24.

The friend key 24 that is registered in both the friend terminal 23 and the vehicle 30 is enabled between the friend terminal 23 and the vehicle 30. The friend key 24 thus enabled can be used on the friend terminal 23 as a digital key for the vehicle 30.

In this way, when the friend key 24 is issued to the friend terminal 23, the processing circuit 11 of the information processing device 10 transmits correction values regarding the friend terminal 23 to the vehicle 30 before enabling by pairing between the friend terminal 23 and the vehicle 30.

### Operations of Present Embodiment

The database 13 in which correction values corresponding to each model are stored is recorded in the storage device 12 of the information processing device 10. Accordingly, there is no need for each vehicle 30 to measure distance and to measure signal strength in order to calculate the correction values. Also, the database 13 does not need to be stored in a storage device of each vehicle 30.

### Effects of Present Embodiment

(1) The information processing device 10 can realize calibration without increasing the processing load on the vehicle 30 or overwhelming the capacity of the storage device on the vehicle 30 side due to the database 13.

(2) The vehicle 30 performs ranging through communication with the mobile information terminal 20 by Bluetooth Low Energy (BLE). The processing circuit 11 of the information processing device 10 executes transmission of correction values regarding communication by BLE, as the correction values. This enables the information processing device 10 to realize calibration regarding ranging by communication by BLE.

(3) The vehicle 30 performs ranging through communication with the mobile information terminal 20 using ultra wide band (UWB). The processing circuit 11 of the information processing device 10 executes transmission of correction values regarding communication by UWB, as the correction values. Thus, the information processing device 10 can realize calibration regarding ranging through communication by UWB with the vehicle 30.

(4) In the network system 100, the vehicle 30, the mobile information terminal 20 in which the digital key of the vehicle 30 is registered, and the information processing device 10, are mutually communicatively connected to each other. In the network system 100, the information processing device 10 includes the processing circuit 11 and the storage device 12. The storage device 12 stores the database 13, in which correction values, for calibration of the ranging performed by the vehicle 30 to determine that the mobile information terminal 20 is within the operating area of the digital key, are recorded in advance for each model of the mobile information terminal 20. The processing circuit 11 of the information processing device 10 in the network system 100 executes acquisition of information for identifying the model from the mobile information terminal 20. The processing circuit 11 of the information processing device 10 in the network system 100 executes extraction of correction values corresponding to the model of the mobile information terminal 20 from the database 13, based on the information that is acquired. The processing circuit 11 of the information processing device 10 in the network system 100 executes transmission of the correction values that are extracted to the vehicle 30. In the network system 100, the vehicle 30 performs calibration of ranging, based on the correction values that are received.

In the network system 100, the database 13 in which correction values corresponding to each model are stored is recorded in the storage device 12 of the information processing device 10. Accordingly, there is no need for each vehicle 30 to measure distance and to measure signal strength in order to calculate the correction values. Also, the database 13 does not need to be stored in a storage device of each vehicle 30. That is to say, according to the above configuration, calibration can be realized without increasing the processing load on the vehicle 30 or overwhelming the capacity of the storage device on the vehicle 30 side due to the database 13.

(5) In the network system 100, the vehicle 30 performs ranging through communication with the mobile information terminal 20 by Bluetooth Low Energy (BLE). The processing circuit 11 of the information processing device 10 in the network system 100 executes transmission of correction values regarding communication by BLE, as the correction values. This enables the network system 100 to realize calibration regarding ranging through communication by BLE.

(6) In the network system 100, the vehicle 30 performs ranging through communication with the mobile information terminal 20 by ultra wide band (UWB). The processing circuit 11 of the information processing device 10 in the network system 100 executes transmission of correction values regarding communication by UWB, as the correction values. This enables the network system 100 to realize calibration regarding ranging through communication by UWB.

(7) In the network system 100, the owner terminal 21 is a mobile information terminal 20 owned by the owner of the vehicle 30. In the network system 100, the owner key 22 is a digital key for the owner of the vehicle 30. After pairing between the owner terminal 21 and the vehicle 30 is completed, the processing circuit 11 of the information processing device 10 executes transmission of correction values regarding the owner terminal 21 to the vehicle 30 when the owner key 22 is generated and enabled in the owner terminal 21.

In the network system 100, the information processing device 10 transmits correction values to the vehicle 30 at the timing at which the owner key 22 is enabled. This enables the network system 100 to perform calibration promptly when the owner key 22 is enabled.

(8) When an owner applies for a digital key for the vehicle 30 that he or she owns to be issued for another particular user, and a friend key 24, which is a digital key issued to the friend terminal 23 that is a mobile information terminal 20 owned by the particular user, is issued to the friend terminal 23, the processing circuit 11 of the information processing device 10 in the network system 100 executes transmitting of correction values regarding the friend terminal 23 to the vehicle 30 before enabling by pairing of the friend terminal 23 with the vehicle 30.

When enabling a digital key, the owner of the digital key pairs the vehicle 30 with the mobile information terminal 20 to which the digital key is to be registered. In the above-described network system 100, when the friend key 24 is issued, the information processing device 10 transmits correction values to the vehicle 30 without waiting for the friend key 24 to be enabled by pairing. This allows the network system 100 to perform calibration before pairing the vehicle 30 and the friend terminal 23.

(9) When the friend key 24 is issued to the friend terminal 23, the processing circuit 11 of the information processing device 10 in the network system 100 executes transmission of correction values regarding the friend terminal 23 to the vehicle 30. This enables the network system 100 to perform calibration promptly after the friend key 24 is issued.

(10) The calibration method is applied to the network system 100 in which the vehicle 30, the mobile information terminal 20 in which a digital key for the vehicle 30 is registered, and the information processing device 10, are mutually communicatively connected to each other. The information processing device 10 includes the processing circuit 11 and the storage device 12. The storage device 12 stores the database 13, in which correction values, for calibration of the ranging performed by the vehicle 30 to determine that the mobile information terminal 20 is within the operating area of the digital key, are recorded in advance for each model of the mobile information terminal 20. The calibration method includes using the processing circuit 11 to execute the acquisition of information identifying the model from the mobile information terminal 20. The calibration method includes using the processing circuit 11 to execute extracting of correction values corresponding to the model of the mobile information terminal 20 from the database 13 based on the information that is acquired. The calibration method includes using the processing circuit 11 to execute transmission of the correction values that are extracted to the vehicle 30. The calibration method includes using the vehicle 30 to perform calibration of ranging based on the correction values that are received.

The above calibration method utilizes the database 13 recorded in the storage device 12 of the information processing device 10. Accordingly, there is no need for each vehicle 30 to measure distance and to measure signal strength in order to calculate the correction values. Also, the database 13 does not need to be stored in a storage device of each vehicle 30. That is to say, according to the above calibration method, calibration can be realized without increasing the processing load on the vehicle 30, overwhelming the capacity of the storage device on the vehicle 30 side due to the database 13, or the like.

### Modifications

The present embodiment can be carried out modified as follows. The present embodiment and the following modifications can be carried out combined with each other as long as no technical contradiction arises.

In the above embodiment, the information processing device 10 transmits the correction values to the vehicle 30 when the friend key 24 is issued to the friend terminal 23. On the other hand, the information processing device 10 may transmit the correction values at any timing after the friend key 24 is issued to the friend terminal 23 and before enabling is performed by pairing between the friend terminal 23 and the vehicle 30.

In the above embodiment, the operating area of the vehicle 30 is made up of the first operating areas 31 set toward the sides and to rear of the vehicle 30, and the second operating area 32 set inside the vehicle. On the other hand, the number, shape, positions and sizes of the operating areas can be optionally set. For example, the operating area of the vehicle 30 may extend in a circular shape with the vehicle 30 at the center thereof.

In the above embodiment, the friend terminal 23 transmits an application for usage of the friend key 24 to the owner terminal 21, in the upper part of FIG. 5. On the other hand, application for usage of the friend key 24 may be made from a device other than the friend terminal 23 to which the friend key 24 is registered. For example, an application for usage of the friend key 24 may be transmitted from a dealer at which the user of the friend key 24 has a contract. An application for usage of the friend key 24 may be transmitted from the owner terminal 21. For example, in these cases, application for usage is performed with the registration destination of the friend key 24 specified.

In the above embodiment, the owner terminal 21 creates the public key and the private key of the owner key 22 after pairing with the vehicle 30 is completed. On the other hand, the owner terminal 21 may generate the public key and the private key of the owner key 22 before pairing with the vehicle 30 is completed. In this case, the processing circuit 11 of the information processing device 10 may transmit correction values corresponding to the owner terminal 21 after the owner terminal 21 creates the public key and the private key of the owner key 22, and before pairing with the vehicle 30.

In the above embodiment, the friend terminal 23 creates the public key and the private key of the friend key 24 before pairing with the vehicle 30. On the other hand, the friend terminal 23 may create the public key and the private key of the friend key 24 after pairing with the vehicle 30 is completed. In this case, the processing circuit 11 of the information processing device 10 may transmit correction values regarding the friend terminal 23 to the vehicle 30 when the friend key 24 is enabled, after pairing of the friend terminal 23 with the vehicle 30 is completed.

In the above embodiment, the friend terminal 23 transmits model information of the friend terminal 23 to the information processing device 10. On the other hand, the model information of the friend terminal 23 may be transmitted from the owner terminal 21.

In this case, the owner terminal 21 acquires the model information of the friend terminal 23 by receiving the model information of the friend terminal 23 from the friend terminal 23, for example. The owner terminal 21 may acquire the model information of the friend terminal 23 by having the model information of the friend terminal 23 directly input by the owner, the user of the friend terminal 23, or the like.

Having acquired the model information of the friend terminal 23 in this way, the owner terminal 21 transmits the model information of the friend terminal 23 to the information processing device 10 at the same time as transmitting the application for issuing the friend key 24 as shown in the upper part of FIG. 5, for example.

### APPENDIX

Technical ideas that can be comprehended from the above embodiment and modifications will be described.

[Appendix 1] A network system in which a vehicle, a mobile information terminal in which a digital key of the vehicle is registered, and an information processing device, are mutually communicatively connected to each other, wherein the information processing device includes a processing circuit, and a storage device in which a database is stored, in which a correction value for calibration of ranging, performed by the vehicle to determine that the mobile information terminal is within an operating area of the digital key, is recorded in advance for each model of the mobile information terminal, in which the processing circuit is configured to execute acquiring of information for identifying the model from the mobile information terminal, extracting of the correction value corresponding to the model of the mobile information terminal, from the database, based on the information that is acquired, and transmitting of the correction value that is extracted, to the vehicle, and the vehicle is configured to perform calibration of the ranging based on the correction value that is received.

[Appendix 2] The network system according to [Appendix 1], wherein the vehicle is configured to perform the ranging through communication with the mobile information terminal by Bluetooth Low Energy (BLE), and the processing circuit is configured to execute transmitting of a correction value regarding the communication by the BLE, as the correction value.

[Appendix 3] The network system according to [Appendix 1] or [Appendix 2], wherein the vehicle is configured to perform the ranging through communication with the mobile information terminal by ultra wide band (UWB), and the processing circuit is configured to execute transmitting of a correction value regarding the communication by the UWB, as the correction value.

[Appendix 4] The network system according to any one of [Appendix 1] to [Appendix 3], wherein the processing circuit is configured to, when pairing between an owner terminal that is the mobile information terminal owned by an owner of the vehicle and the vehicle is completed and an owner key that is the digital key for the owner of the vehicle is generated and enabled in the owner terminal, execute transmitting of the correction value regarding the owner terminal to the vehicle.

[Appendix 5] The network system according to any one of [Appendix 1] to [Appendix 4], wherein the processing circuit is configured such that, when the owner applies for a digital key for the vehicle that he or she owns to be issued to another particular user, and a friend key, which is the digital key issued to the friend terminal that is the mobile information terminal owned by the particular user, is issued to the friend terminal, the processing circuit executes transmitting of the correction value regarding the friend terminal to the vehicle before enabling by pairing of the friend terminal with the vehicle.

[Appendix 6] The network system according to [Appendix 5], wherein the processing circuit is configured to execute transmitting of the correction value regarding the friend terminal to the vehicle when the friend key is issued to the friend terminal.

What is claimed is:

1. An information processing device that is configured to communicate with both a vehicle and a mobile information terminal in which a digital key for the vehicle is registered, the information processing device comprising:
a processing circuit; and
a storage device in which a database is stored, in which a correction value for calibration of ranging, performed by the vehicle to determine that the mobile information terminal is within an operating area of the digital key, is recorded in advance for each model of the mobile information terminal, wherein the processing circuit is configured to execute
acquiring of information for identifying the model from the mobile information terminal,
extracting of the correction value corresponding to the model of the mobile information terminal, from the database, based on the information that is acquired, and
transmitting of the correction value that is extracted, to the vehicle.

2. The information processing device according to claim 1, wherein
the vehicle is configured to perform the ranging through communication with the mobile information terminal by Bluetooth Low Energy, and
the processing circuit is configured to execute transmitting of a correction value regarding the communication by the Bluetooth Low Energy, as the correction value.

3. The information processing device according to claim 1, wherein
the vehicle is configured to perform the ranging through communication with the mobile information terminal by ultra wide band, and
the processing circuit is configured to execute transmitting of a correction value regarding the communication by the ultra wide band, as the correction value.

4. A network system comprising:
a vehicle;
a mobile information terminal in which a digital key of the vehicle is registered; and
an information processing device, wherein the vehicle, the mobile information terminal and the information processing device are connected to communicate with each other, wherein
the information processing device includes
a processing circuit, and
a storage device in which a database is stored, in which a correction value for calibration of ranging, performed by the vehicle to determine that the mobile information terminal is within an operating area of the digital key, is recorded in advance for each model of the mobile information terminal, in which the processing circuit is configured to execute
acquiring of information for identifying the model from the mobile information terminal,
extracting of the correction value corresponding to the model of the mobile information terminal, from the database, based on the information that is acquired, and
transmitting of the correction value that is extracted, to the vehicle, and
the vehicle is configured to perform calibration of the ranging based on the correction value that is received.

5. The network system according to claim 4, wherein
the vehicle is configured to perform the ranging through communication with the mobile information terminal by Bluetooth Low Energy, and
the processing circuit is configured to execute transmitting of a correction value regarding the communication by the Bluetooth Low Energy, as the correction value.

6. The network system according to claim 4, wherein
the vehicle is configured to perform the ranging through communication with the mobile information terminal by ultra wide band, and
the processing circuit is configured to execute transmitting of a correction value regarding the communication by the ultra wide band, as the correction value.

7. The network system according to claim 4, wherein the processing circuit is configured to, when pairing between an owner terminal that is the mobile information terminal owned by an owner of the vehicle and the vehicle is completed and an owner key that is the digital key for the owner of the vehicle is generated and enabled in the owner terminal, execute transmitting of the correction value regarding the owner terminal to the vehicle.

8. A calibration method applied to a network system in which a vehicle, a mobile information terminal in which a digital key of the vehicle is registered, and an information processing device, are connected to communicate with each other, the information processing device including a processing circuit, and a storage device in which a database is stored, in which a correction value for calibration of ranging, performed by the vehicle to determine that the mobile information terminal is within an operating area of the digital key, is recorded in advance for each model of the mobile information terminal, the calibration method comprising:
executing acquiring of information identifying the model from the mobile information terminal, using the processing circuit;
executing extracting of the correction value corresponding to the model of the mobile information terminal based on the information that is acquired, from the database, using the processing circuit;
executing transmitting of the correction value that is extracted, to the vehicle, using the processing circuit; and
calibrating the ranging based on the correction value that is received, using the vehicle.
